(19) United States
(12) Patent Application Publication
(10) Pub. No.: US 2025/0118504 A1
(43) Pub. Date: Apr. 10, 2025

(54) INTERLOCK MECHANISM, RELATED INTERLOCK ASSEMBLIES AND METHODS OF USE

(71) Applicant: Generator Interlock Technologies, LLC, Richmond, VA (US)

(72) Inventors: Douglas E. Albertson, Richmond, VA (US); Christian Blake McGovern, Chesterfield, VA (US); Theodore Montague Mitchell, Naples, FL (US)

(21) Appl. No.: 18/888,479

(22) Filed: Sep. 18, 2024

Related U.S. Application Data
(60) Provisional application No. 63/589,211, filed on Oct. 10, 2023.

(51) Int. Cl. H01H 9/20; H02B 1/04; H02J 3/38

(52) U.S. Cl. CPC H01H 9/20; H02B 1/04; H02J 3/38

(57) ABSTRACT

The present disclosure describes an interlock assembly adapted to interact with a plurality of circuits, switches and/or toggles to direct a desired flow of energy. The interlock assembly includes an electrical panel assembly and an interlock mechanism movably connected to the electrical panel assembly. The electrical panel assembly has a cover and a series of electrical circuits including a main switch and at least two alternate switches. The interlock mechanism is configured to prevent the main switch and the at least two alternate switches from being concurrently engaged based on the desired flow of energy. An interlock mechanism and other related interlock assemblies are described herein.

### RELATED APPLICATION(S)

The present application claims priority to and the benefit of U.S. Provisional Patent Application Ser. No. 63/589,211, filed Oct. 10, 2023, the disclosures of which are hereby incorporated by reference in their entirety.

### FIELD

The present application relates generally to electrical panels, and more particularly, to an interlock mechanism and related power supply or input interlock assemblies constructed to electrically isolate different inputs connected to an electrical panel, as well as methods of using same.

### BACKGROUND

Electrical panels, breaker boxes, or load centers frequently include a main contact, switch, or breaker, which electrically isolates a series of load breakers from a primary or utility power input. Occasionally, such load panels are configured to receive another input power source. When a pair of circuit breakers are connected to separate power systems, it is critical that both power systems are not connected to a common load at the same time. This is especially true, for example, when a utility power source is connected to a load through a first circuit breaker and an auxiliary power supply, such as a local generator system or photovoltaic (solar) system, is connected to the same load through a second circuit breaker. The generator system and photovoltaic system are configured to supply power to the load center, which the load center distributes to the selected or designated circuits of the building.

Before activating the generator power supply. the main power switch and photovoltaic switch, where applicable, must be in an “OFF” position before the generator switch can be moved to an “ON” position. The main power switch must be disconnected to prevent the generator from back feeding through the primary power supply conductors. In order to maintain electrical isolation between the generator power input and the primary power input (and photovoltaic power input), the connection/disconnection of the primary power supply, photovoltaic power supply, and generator power supply must be performed in a specific sequence to ensure electrical isolation of the respective input powers. In many instances, a user must manually configure the switches of the load center to electrically connect the generator power with the series of loads and electrically isolate the primary power (and photovoltaic power) from the generator power, and vice-versa.

Interlock devices are used which will allow only one of the interlocked circuit breakers to be in the “ON” position such that the other circuit breaker must remain in the “OFF” position. However, currently available interlock arrangements only allow for interlocking two independent power source breakers (typically, utility and generator) such that only one power source breaker can be connected to the load center at a time. See, e.g., U.S. Pat. No. 3,492,448 to Phillips, Jr., U.S. Pat. No. 4,924,041 to Yee, U.S. Pat. No. 6,184,595 to Flegel, Jr., and U.S. Pat. No. 8,110,759 to Flegel. There may be a need for interlock arrangements that allow for interlocking multiple (i.e., more than two) independent power sources or load breakers.

### SUMMARY

A first aspect of the present invention is directed to an interlock assembly adapted to interact with a plurality of circuits, switches and/or toggles to direct a desired flow of energy. The interlock assembly includes an electrical panel assembly and an interlock mechanism movably connected to the electrical panel assembly. The electrical panel assembly has a cover and a series of electrical circuits including a main switch and at least two alternate switches. The interlock mechanism is configured to prevent the main switch and the at least two alternate switches from being concurrently engaged based on the desired flow of energy.

A second aspect of the present invention is directed to an interlock assembly adapted to interact with a plurality of circuits, switches and/or toggles to direct a desired flow of energy from a primary power source and at least two alternate power sources, where the at least two alternate power sources include a generator system and a photovoltaic system. The interlock assembly includes an electrical panel assembly and an interlock mechanism movably connected to the electrical panel assembly. The electrical panel assembly includes a cover, a series of electrical circuits, a main power switch connected to the primary power source, and at least two alternate power switches, where the at least alternate power switches include a generator switch connected the generator system and a photovoltaic switch connected to the photovoltaic system. The interlock mechanism is configured to prevent the primary power source and the photovoltaic system from being concurrently connected to the series of electrical circuits of the electrical panel assembly at the same time as the generator system, or prevent the generator system from being concurrently connected to the series of electrical circuits of the electrical panel assembly at the same time as the primary power source and the photovoltaic system.

A third aspect of the present invention is directed to an interlock mechanism for an electrical panel assembly. The interlock mechanism includes a back plate and a front plate. The back plate has a first end, an opposing second end, and an aperture between the first and second ends that is configured to receive a fastener to affix the back plate to the electrical panel assembly. The front plate has a first end, an opposing second end, and a slot aligned along a longitudinal or latitudinal axis of the front plate between the first and second opposing ends. The slot is configured to align with the aperture in the back plate such that, when the fastener is received through the aligned aperture and slot, the front plate can move relative to the back plate. Movement of the front plate relative to the back plate allows the first end of the front plate to engage with a main power circuit, switch, or breaker and a first alternate power circuit, switch, or breaker of the electrical panel assembly and allows the opposing second end of the front plate to engage with a second alternate power circuit, switch, or breaker of the electrical panel assembly, thereby preventing the main power circuit, switch, or breaker and the first and/or second alternate power circuit, switch, or breaker from being improperly engaged based on a desired flow of energy.

A fourth aspect of the present invention is directed to a method of installing an interlock mechanism to an electrical panel assembly for the purpose of creating a capacity threshold in the electrical panel assembly to protect integrated power sources from overloading caused by high amperage appliances. The electrical panel assembly includes at least three breakers that need to be controlled when a power source is supplying power within the electrical panel assembly. The interlock mechanism includes a back plate having a first end, an opposing second end, and an aperture between the first and second opposing ends and a front plate having a first end, an opposing second end, and a slot aligned along a longitudinal or latitudinal axis of the front plate between the first and second opposing ends. A fastener is received through the aperture and the slot to movably secure the interlock mechanism to the electrical panel assembly. The method includes moving the front plate of the interlock mechanism in a first direction relative to the back plate of the interlock mechanism such that the first end of the front plate engages with a first breaker and disengages from a second breaker and the opposing end of the front plate disengages from a third breaker or alternatively, moving the front plate in a second opposing direction relative to the back plate such that the first end of the front plate engages with the second breaker and disengages from the first breaker and the opposing end of the front plate engages with the third breaker; and tightening the fastener to secure the front plate from moving relative to the back plate.

A fifth aspect of the present invention is direct to an interlock assembly adapted to interact with a plurality of circuits, switches, and/or toggles to direct a desired flow of energy from a primary power source and at least two alternative power sources. The two alternative power sources require a transfer switch configured to prevent a potential catastrophic or fatal flow of energy. The interlock assembly includes an electrical panel assembly having a cover, a series of electrical circuits, a main power switch connected to the primary power source, and the two alternate power sources. One of the alternative power sources is a grid-tied power system configured to feed surplus power back to a utility and the other alternative power source is an independent power system from the grid-tied power system operating as standby emergency power. The interlock assembly further includes an interlock mechanism movably connected to the electrical panel assembly. The interlock mechanism is configured to prevent the primary power source and the grid-tied power system from being concurrently connected to the series of electrical circuits of the electrical panel assembly at the same time as the independent power system, or prevent the independent power system from being concurrently connected to the series of electrical circuits of the electrical panel assembly at the same time as the primary source and the grid-tied power system.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a front view of an interlock assembly according to embodiments of the present invention.

FIG. 2A is a front view of a first plate for an interlock mechanism of the interlock assembly of FIG. 1 according to embodiments of the present invention.

FIG. 2B is a front view of a second plate for the interlock mechanism of the interlock assembly of FIG. 1 according to embodiments of the present invention.

FIG. 2C is a side view of the first plate for the interlock mechanism of FIG. 2A.

FIG. 3A is a front view of the interlock assembly of FIG. 1 illustrating the main switch and the photovoltaic switch in an “ON” position according to embodiments of the present invention.

FIG. 3B is a front view of the interlock assembly of FIG. 1 illustrating the generator switch in an “ON” position according to embodiments of the present invention.

FIGS. 4A-4B and FIGS. 5A-5E illustrate installation and exemplary use of the interlock mechanism of FIGS. 2A-2C on a panel assembly according to embodiments of the present invention.

FIG. 6 is a front view of an alternative electrical interlock assembly according to embodiments of the present invention.

FIG. 7A and FIG. 7B illustrate an exemplary locking feature for the interlock mechanism of FIGS. 2A-2C according to embodiments of the present invention.

FIG. 8A is a front view of another interlock assembly utilizing an alternative interlock mechanism according to embodiments of the present invention and illustrating the main switch in an “ON” position.

FIG. 8B is a front view of the interlock assembly and interlock mechanism of FIG. 8A illustrating the main switch in an “OFF” position.

FIG. 9A is a front view of a first plate for the interlock mechanism shown in FIGS. 8A-8B according to embodiments of the present invention.

FIG. 9B is a front view of a second plate for the interlock mechanism shown in FIGS. 8A-8B according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

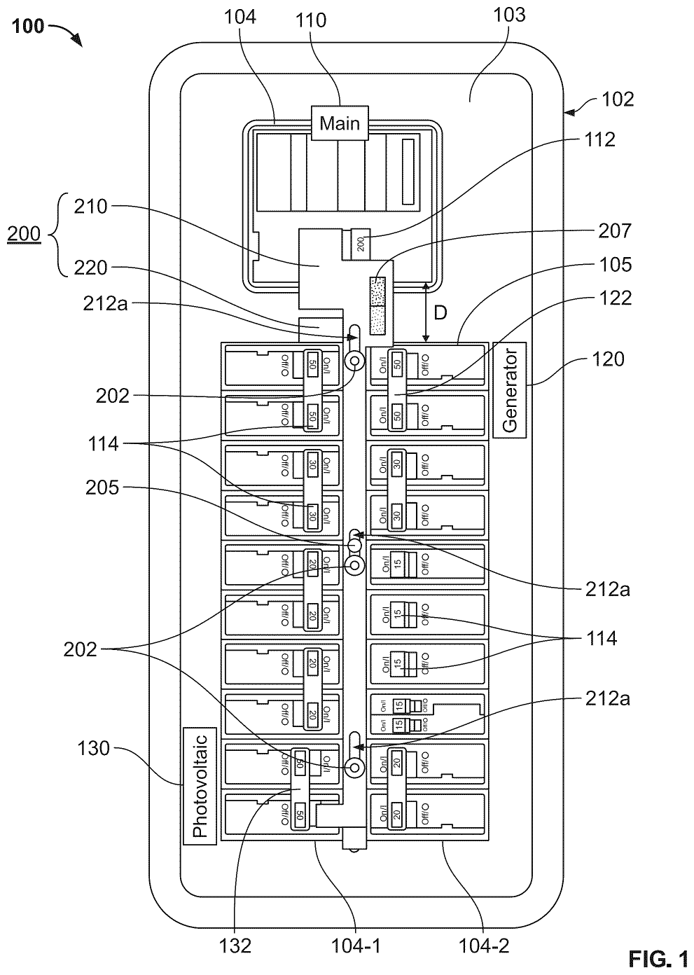

Pursuant to embodiments of the present invention, an interlock assembly having an interlock mechanism constructed to electrically isolate inputs from at least three different power sources connected to a panel assembly is provided. The interlock mechanism allows for interlocking of more than two power source breakers within the assembly when a specific power source is selected. The interlock mechanism of the present invention allows for significant cost savings while providing safe and reliable interlocking of the power sources. Embodiments of the present invention will now be discussed in greater detail with reference to FIGS. 1-9B.

Referring now to FIG. 1, an interlock assembly (e.g., an electrical interlock assembly) according to embodiments of the present invention, designated broadly at 100, is illustrated. The interlock assembly 100 is configured to supply power to a series of electrical circuits 114 from one of at least three different power sources. Representatively, the interlock assembly 100 of the present invention controls the supply of power to the electrical circuits from a primary (main) power supply 110, such as utility power, and two or more alternate or secondary power sources which are adapted to supply power to the electrical circuits 114, for example, in the event power from the primary power supply 110 is unavailable. In some embodiments, the alternate or secondary power sources are a generator system 120 and a photovoltaic (solar) system 130, although it is understood that any other source of alternate or secondary power may be employed in the interlock assembly 100 of the present invention.

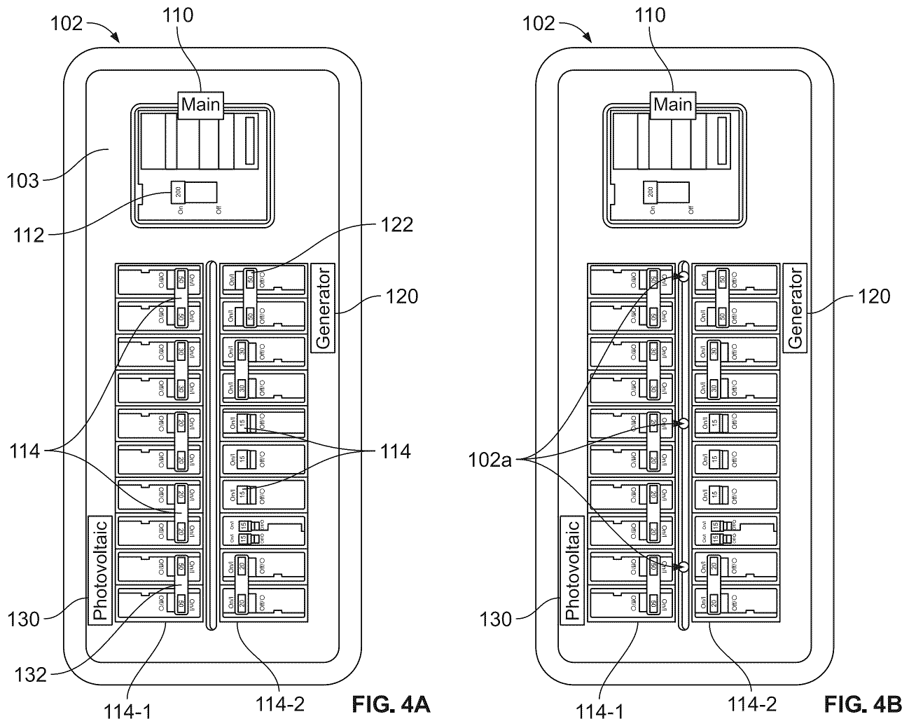

As shown in FIG. 1, according to embodiments of the present invention, the interlock assembly 100 includes a panel assembly 102 (e.g., an electrical panel assembly) and an interlock mechanism 200. Apart from the interlock mechanism 200, the panel assembly 102 may be of conventional construction, and may incorporate a standard, commercially available electrical load center. In some embodiments, the panel assembly 102 may be a top-fed breaker panel in which the main breaker is located at the top of the panel and the power feeds into it from above. In other embodiments, the panel assembly 102 may be a bottom-fed panel in which the main breaker is at the bottom, and the power feeds into it from below. In some embodiments, the panel assembly 102 includes a panel cover 103 having a door (not shown) pivotably connected thereto. Cover 103 includes a series of knockouts 104 constructed to be removed as electrical circuits 114 (i.e., branch circuit or load breakers) are added to electrical panel assembly 102 (see also FIGS. 4A-4B). The electrical circuits 114 are connected to an electrical panel busbar (not shown). In some embodiments, the electrical circuits include a main switch 112 and at least two alternate switches 122, 132. It is noted that while the electrical panel busbar is not shown in the figures, one of ordinary skill in the art would understand that it would reside behind the cover 103 of the panel assembly 102. As shown in FIG. 1 (and FIGS. 4A-4B), in some embodiments, the electrical circuits 114 may be arranged within the panel assembly 102 in two columns 114-1, 114-2.

The primary (main) source of electrical power 110, such as utility power, is supplied to the panel assembly 102. The main switch (or breaker) 112 passes through the cover 103. In some embodiments, the main switch 112 is constructed to be connected to the primary power source 110. As illustrated in FIG. 1, in some embodiments, the main switch 112 may reside a distance D from the electrical circuits 114 within the panel assembly 102. For example, in some embodiments, the main switch 112 resides a distance D from an uppermost electrical circuit 114 in a range of between about 0.5 inches and about 5 inches, typically about 1 inch. In some embodiments, a first alternate source of electrical power, such as from a generator system 120, may be supplied to the panel assembly 102. A generator switch (breaker) 122 passes through one or more of the knockouts 104 in the cover 103 and is constructed to be connected to the first alternate source of electrical power (e.g., generator system 120). As shown in FIG. 1, in some embodiments, the generator switch 122 may reside proximate to the main switch 112 along the electrical panel busbar (e.g., an upper segment of the busbar).

As further shown in FIG. 1, in some embodiments, a second alternate source of electrical power, such as from a photovoltaic system 130, may also be supplied to the panel assembly 102. A photovoltaic switch (breaker) 132 passes through one or more of the knockouts 104 in the cover 103 and is constructed to be connected to the second alternate source of electrical power (e.g., photovoltaic system 130). In some embodiments, the first or second alternate source of electrical power may be supplied from a battery system.

It is noted that electrical codes in some jurisdictions may require that when a photovoltaic system 130 is connected to the panel assembly 102, the photovoltaic switch 132 must reside at the opposite end of the electrical panel busbar from the main switch 112. This helps prevent catastrophic or fatal back-feeding from multiple integrated power sources. Currently, multi-breaker kits are installed in electrical panel assemblies to interact with main breakers, grid-tied breakers and independent power source breakers. For example, grid-tied solar (photovoltaic) systems run simultaneously with the main grid power, but is turned off along with the grid when a back-feed generator system (i.e., independent source) is running. Multi-breaker kits may be customized to abide by the authority having jurisdiction (AHJ) and National Electric Code (NEC) requirements for breaker locations in an electrical panel assembly specific to integrated power systems (grid ties or independent). See, for example, NEC 705.12(D)(2)(3)(b) Busbars Option 2,which states that 125% of the inverter output circuit current plus the rating of the overcurrent protection device (OCPD) protecting the busbar cannot be greater than 120% of the ampacity of the busbar. This method can only be used where a service main breaker is at one end of the busbar and the photovoltaic breaker is at the opposite end. Therefore, the inverter breaker (e.g., the photovoltaic switch 132) must be at the opposite end of the panel assembly 102 to prevent a concentration of current at one end of the busbar. In other words, grid-tied systems must be at the opposite end of the busbar from the main breaker. Accordingly, as shown in FIG. 1, in some embodiments, input from the second alternate source of electrical power, photovoltaic system 130 (and photovoltaic switch 132), may be located at an opposing end of the panel assembly 102 (i.e., a lower segment of the busbar) from the primary power source 110 (main switch 112). In addition, multi-breaker kits could be customized to abide by 705.12(D)(2)(3)(c) , which states that first, the sum of the ampere ratings of all OCPD's on the panel board, both load and supply devices, excluding the rating of the OCPD protecting the busbar, shall not exceed the ampacity of the busbar. Second, the rating of the OCPD protecting the busbar shall not exceed the rating of the busbar.

Current interlock assemblies or kits only provide for preventing two independent breakers or power sources from being turned on at the same time (e.g., utility power source 110 and generator power source 120). Both independent power sources 110, 120 (or breakers) can be turned “off” at the same time, but only one power source 110, 120 (or breaker) can be “on” at a time. These types of interlock kits rely on specific breaker locations for each power source 110, 120 to function properly, such as adjacent (over/under) to each other, opposed (across) from each other, or tangential to each other. See, e.g., U.S. Pat. No. 3,492,448 to Phillips, Jr., U.S. Pat. No. 4,924,041 to Yee, U.S. Pat. No. 6,184,595 to Flegel, Jr., and U.S. Pat. No. 8,110,759 to Flegel. However, in some instances, more than two switches or breakers need to be interlocked, for example, when a photovoltaic (solar) system 130 is attached to the electrical panel busbar with a breaker or a switch (i.e., photovoltaic switch 132).

When a photovoltaic system 130 is attached to the panel assembly 102, the photovoltaic system 130 infeed is typically parallel to the primary power source (i.e., utility) 110 and relies on the primary power source 110 to absorb any additional power that the photovoltaic system 130 may produce in excess of the load needed, e.g., for a house. In instances when a generator system 120 is also connected to the panel assembly 102 and the interlock kit is configured to lock out only the primary power source 110, if the photovoltaic system 130 produces more power than the house requires, then the photovoltaic system 130 will try to “drive” the generator system 120, which may cause a damaging and very unsafe condition. As described in further detail below, according to some embodiments of the present invention, the interlock mechanisms 200, 400 are configured to prevent the main switch 112 and the at least two alternate switches 122, 132 from being concurrently connected to the series of electrical circuits 114 of the panel assembly 102. For example, in some embodiments, the interlock mechanisms 200, 400 may be configured to interlock the primary power source 110 (i.e., main switch 112) and the photovoltaic system 130 (i.e., photovoltaic switch 132) before the generator system 120 (i.e., generator switch 122) may be turned on, or interlock the generator system 120 before the primary power source 110 and the photovoltaic system 130 may be turned on. In other embodiments, as described below, the interlock mechanism 200 of the present invention may also be configured to interlock other or additional breakers or switches (e.g., breaker connected to an air conditioning system) within the panel assembly 102.

As further shown in FIG. 1, the interlock assembly 100 of the present invention includes an interlock mechanism 200 connected to the panel assembly 102. As discussed in further detail below, according to embodiments of the present invention, the interlock mechanism 200 is configured to prevent the connection (e.g., inadvertent) of the primary power source 110, the generator power source (i.e., generator system 120) and/or the solar power source (i.e., photovoltaic system 130) from being concurrently connected to the electrical circuits 114 of the panel assembly 102.

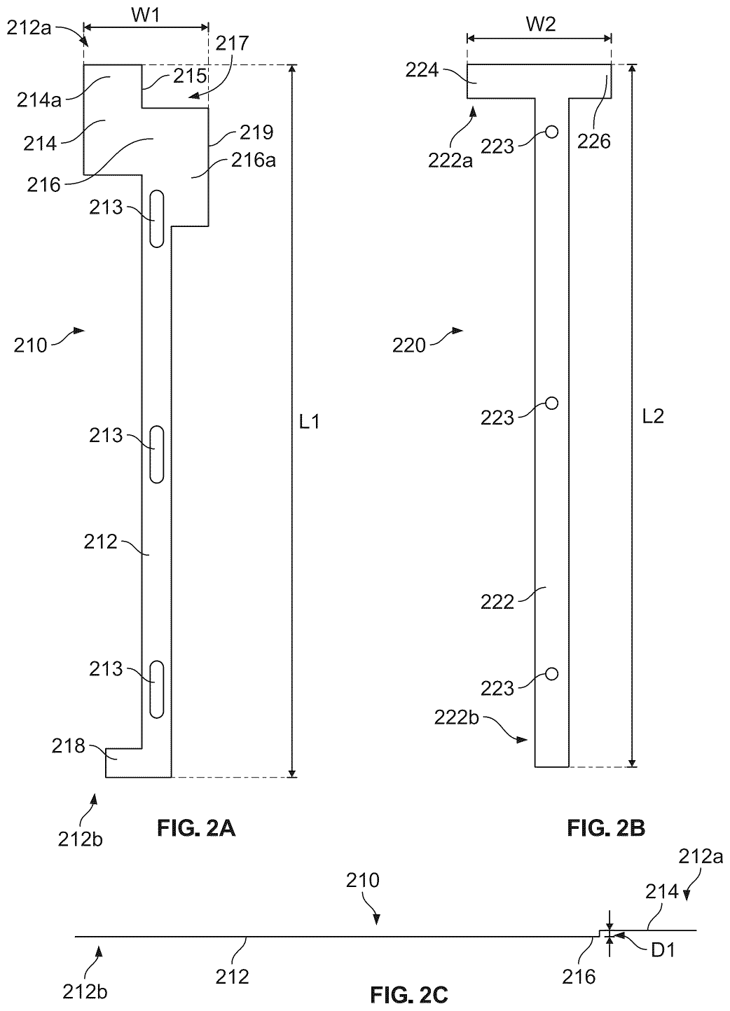

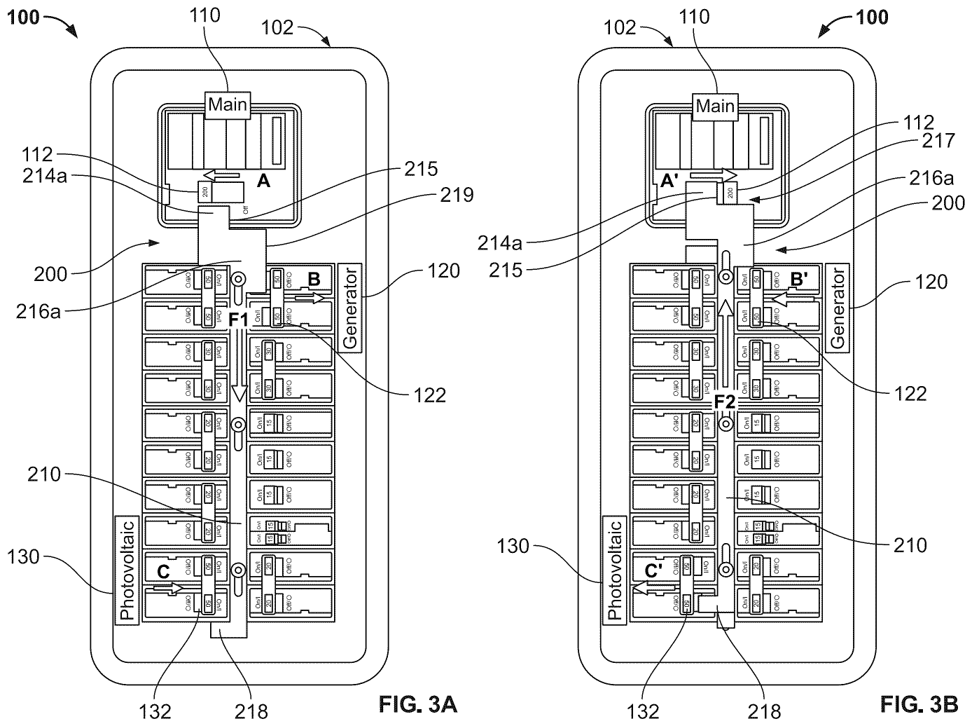

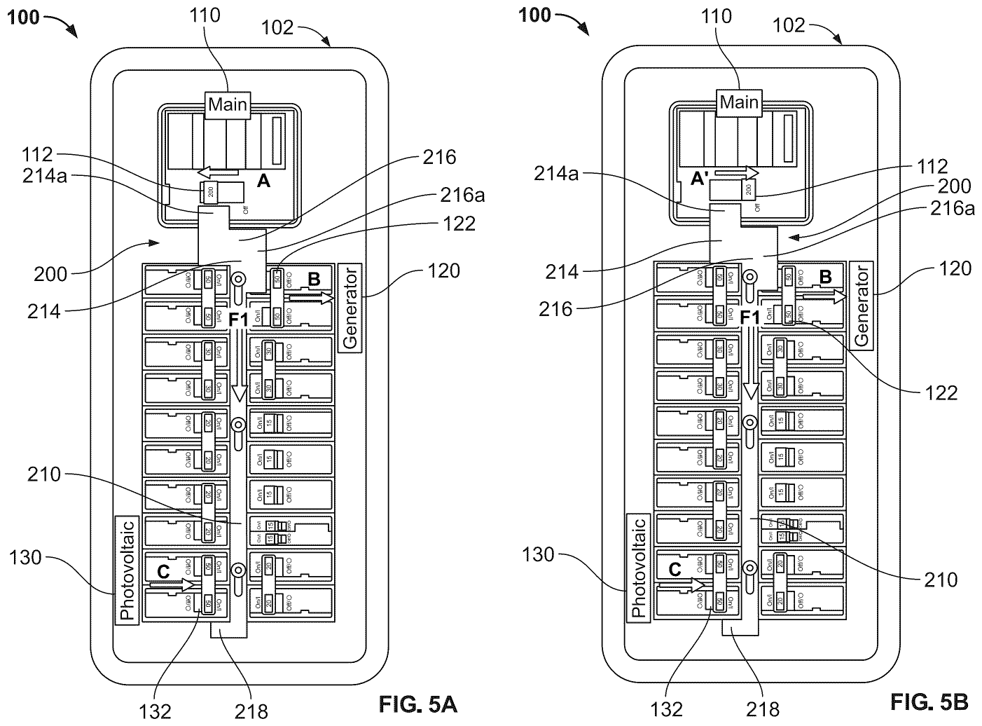

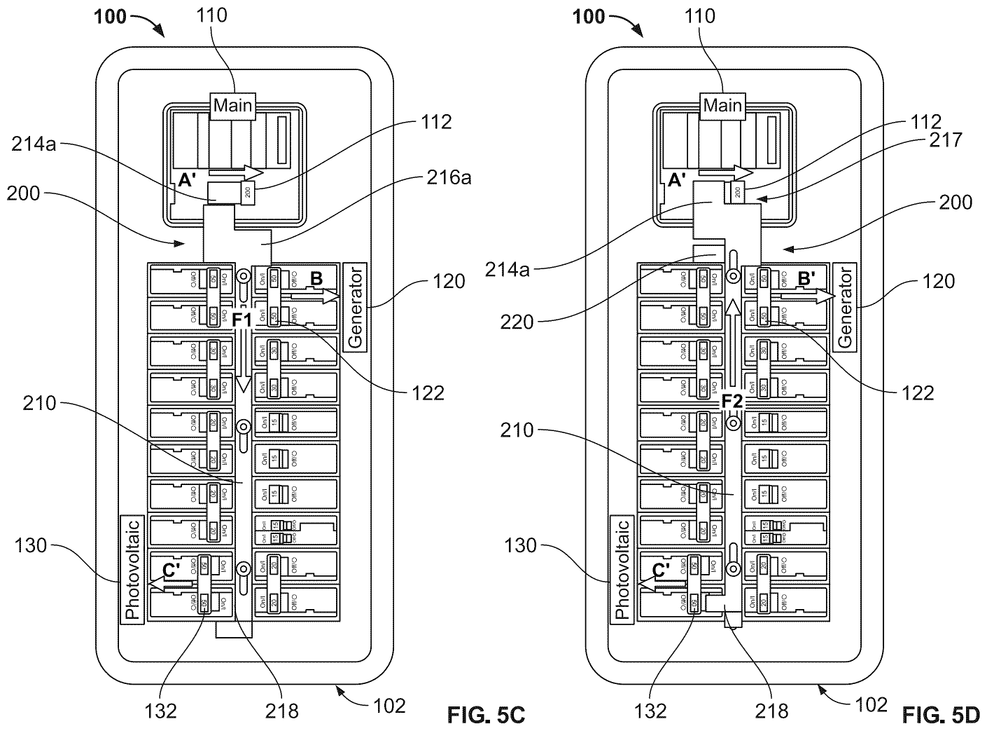

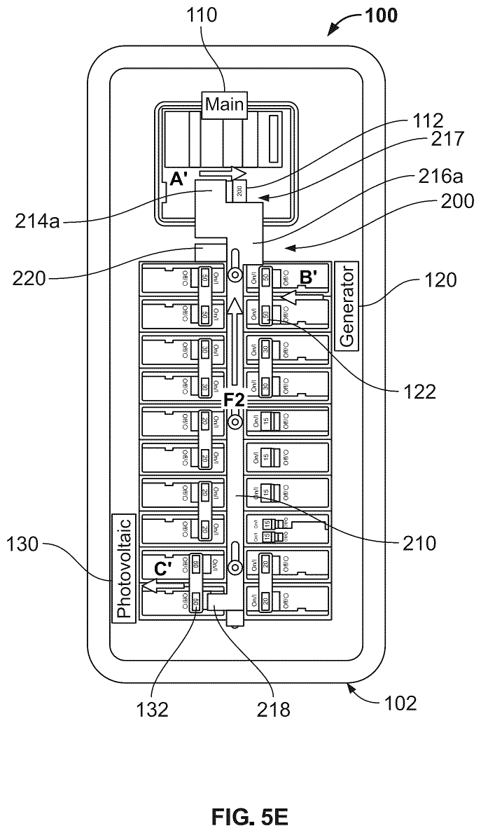

Referring now to FIGS. 2A-2C, components of the interlock mechanism 200 according to embodiments of the present invention are illustrated. As shown in FIGS. 2A and 2C, the interlock mechanism 200 includes a first (or front) plate 210 (see also FIG. 1, FIGS. 3A-3B, and FIGS. 5A-5E). As shown in FIG. 2B, in some embodiments, the interlock mechanism 200 may further include a second (or back) plate 220 (see also FIG. 1). The front plate 210 of the interlock mechanism 200 has a length L1 and a width W1. The interlock mechanism 200 (i.e., front and back plates 210, 220) may be formed from a variety of different materials, for example, steel, stainless steel, aluminum, aluminum alloys, ferrous and non-ferrous materials, plastics or polymers. In some embodiments, the front plate 210 has an overall length L1 in a range of between about 10 inches and about 15 inches and an overall width W1 in a range of between about 1.5 inches and about 3 inches. In some embodiments, the front plate 210 has a sufficient length L1 to extend the entire length of the electrical panel busbar, thereby allowing engagement with a photovoltaic switch 132 residing at the opposing end of the busbar from the main switch 112 (for example, as noted above with respect to electrical codes in some jurisdictions).

The back plate 220 of the interlock mechanism 200 also has a length L2 and a width W1. In some embodiments, the back plate 220 has an overall length L2 in a range of between about 9 inches and about 13 inches and an overall width W2 in a range of between about 1.5 inches and about 3 inches. In some embodiments, the overall width W1 of the front plate 210 is equal to or substantially equal to the overall width W2 of the back plate 220.

As shown in FIG. 2A, the front plate 210 of the interlock mechanism 200 has an elongate main body 212 having an upper end 212a and an opposing lower end 212b. In some embodiments, when installed on the panel assembly 102, the upper end 212a of the front plate 210 is configured to engage the main switch 112 and/or the generator switch 122 and the lower end 212b of the front plate 210 is configured to engage the photovoltaic switch 132. In some embodiments, the upper end 212a of the front plate 210 comprises a main switch section 214 and a generator switch section 216. In some embodiments, the main switch section 214 is configured to engage with the main switch 112 and the generator switch section 216 is configured to engage with the generator switch 122.

In some embodiments, the main switch section 214 of the front plate 210 comprises a segment 214a that extends axially outwardly from the upper end 212a of the main body 212 to form a stop shoulder 215 (i.e., the segment 214a extends outwardly relative to a longitudinal axis of the front plate 210). In some embodiments, the generator switch section 216 of the front plate 210 comprises a segment 216a that extends outwardly from the upper end 210a of the main body 212 (i.e., the segment 216a extends transverse relative to the longitudinal axis of the front plate 210). In some embodiments, the segment 214a of the main switch section 214 and the segment 216a of the generator switch section 216 define a recessed area 217 in the upper end 210a of the front plate 210. In some embodiments, the recessed area 217 is configured to receive the main switch 112 of the panel assembly 102 (see, e.g., FIG. 3B, FIG. 4F, and FIG. 4G). In some embodiments, the stop shoulder 215 is configured to engage with the main switch 112 and prevent the main switch 112 from connecting (e.g., inadvertently) to the primary power source 110. In some embodiments, an edge 219 of the segment 216a of the generator section 216 is configured to engage with the generator switch 122 to prevent the generator switch 122 from connecting (e.g., inadvertently) to the generator system 120.

In some embodiments, the lower end 212b of the front plate 210 comprises a photovoltaic switch section 218. In some embodiments, the photovoltaic switch section 218 is configured to engage with the photovoltaic switch 132. As shown in FIG. 2A, in some embodiments, the photovoltaic switch section 218 extends outwardly from the lower end 212b of the front plate 210 (i.e., the photovoltaic switch section 218 extends transverse relative to the longitudinal axis of the front plate 210). In some embodiments, the photovoltaic switch section 218 may extend outwardly from the main body 212 of the front plate 210 in an opposing direction to the segment 216a of the generator switch section 216.

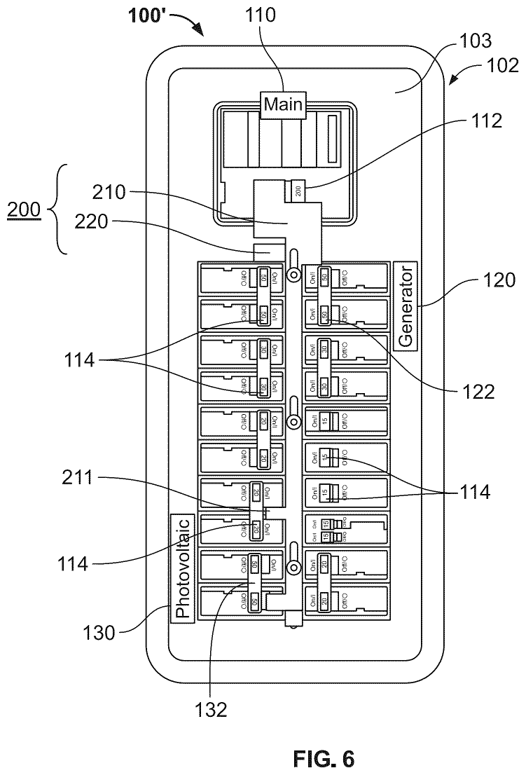

In some embodiments, the front plate 210 may comprise one or more additional electrical circuit sections 211 extending outwardly therefrom (i.e., extending outwardly transverse relative to the longitudinal axis of the front plate 210) (see, e.g., interlock assembly 100′ illustrated in FIG. 6). The one or more additional electrical circuit sections 211 may be configured to prevent a respective electrical circuit 114 from establishing an electrical connection with an alternate circuit. For example, as shown in FIG. 6, if the generator system 120 does not have sufficient power to run an air conditioning system or refrigerator unit, it may be desirable to have the respective electrical circuit (breaker) 114 for the air conditioning unit and/or refrigerator unit to be locked in an “OFF” position, while the generator switch 122 is in an “ON” position. The ability to add one or more electrical circuit sections 211 on the front plate 210 allows the interlock mechanism 200 of the present invention to interlock (i.e., prevent movement) of various electrical circuits 114 in diverse locations within the panel assembly 102. As another example, in some embodiments, the interlock assembly 100′ may be configured to lock out (or on) other electrical loads or systems, such as a battery system, an electric vehicle (EV) charger, or other EV applications that may be connected to the panel assembly 102. According to embodiments of the present invention, the interlock mechanism 200 may be configured to interlock the respective electrical circuit (breaker) 114 connected to the EV charger concurrently with the main switch 112 to avoid inadvertent overload of the generator system 120 (i.e., similar to when a photovoltaic system 130 is connected to the panel assembly 102).

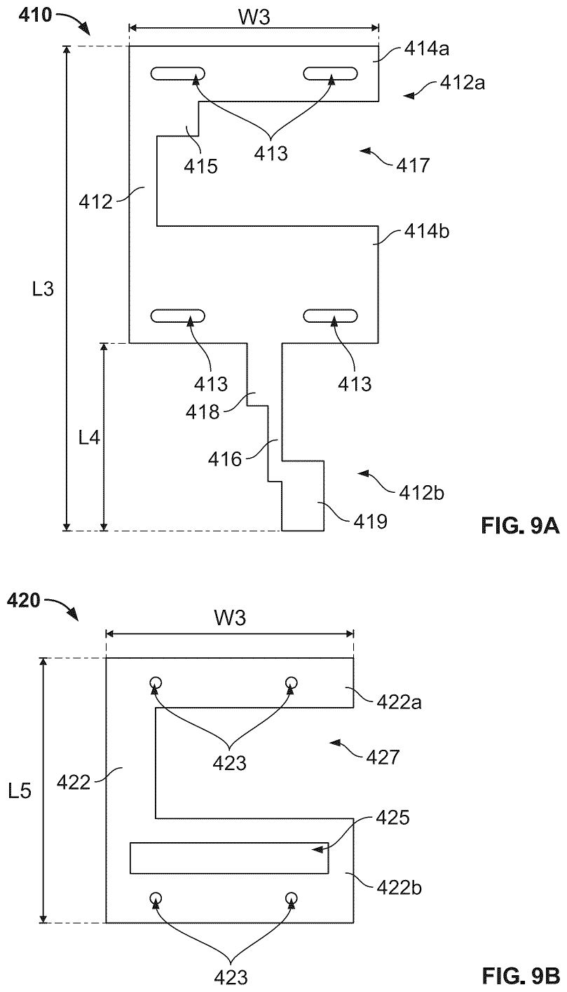

As discussed in further detail below, in some embodiments, the main switch section 214 of the front plate 210 is configured to prevent the main switch 112 from movement when the interlock mechanism 200 is moved into engagement with the main switch 112. Similarly, in some embodiments, the generator switch section 216 and the photovoltaic switch section 218 of the front plate 210 are configured to prevent the generator switch 122 and photovoltaic switch 132, respectively, from movement when the interlock mechanism 200 is moved into engagement with the generator switch 122 or photovoltaic switch 132. As used herein, the terms “engagement,” “engage,” “engaged,” “disengage,” and “disengaged” refer to the position of the front plate 210 relative to the respective switches 112, 122, 132 to allow or prohibit substantial movement of the switches 112, 122, 132 such that connection of the respective power sources 110, 120, 130 is allowed or prevented. The terms “engagement,” “engage,” and “engaged” does not require direct contact of the front plate 210 with the respective switches 112, 122, 132. In addition, it is noted that alternative configurations of the upper and lower ends 212a, 212b of the front plate 210 than those described herein may be contemplated to prevent movement of the respective switches 112, 122, 132 (see, e.g., FIGS. 9A-9B).

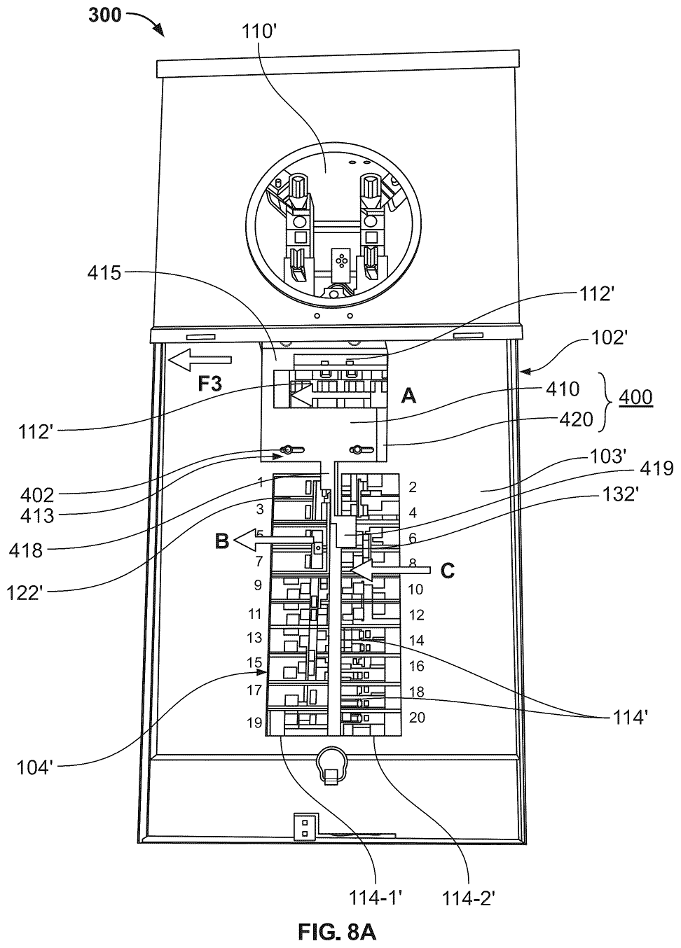

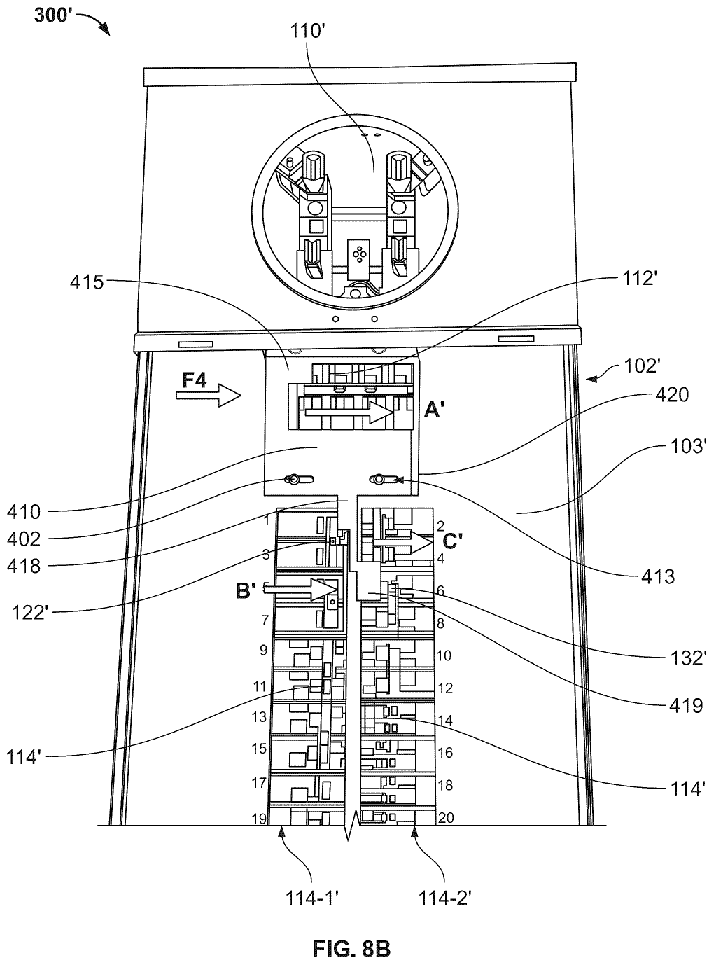

As further shown in FIG. 2A, the main body 212 of the front plate 210 comprises one or more slots 213 aligned along a longitudinal axis of the front plate 210. For example, in some embodiments, the main body 212 of the front plate 210 may comprise three (3) slots 213. In some embodiments, each slot 213 is configured to receive a respective fastener 202 (e.g., a screw and washer) which allows the interlock mechanism 200 to be movably secured to the panel assembly 102. As discussed in further detail below, the fasteners 202 are also configured to traverse within the slots 213, thereby allowing the front plate 210 to move or slide relative to the panel assembly 102 (and back plate 220) to engage or disengage the respective switches 112, 122, 132, as desired (i.e., the slots 213 and fasteners 202 allow up and down movement (i.e., vertical movement) of the front plate 210 relative to the second plate 220 and panel assembly 102). In other embodiments, the front plate 210 may be configured to move side-to-side (i.e., horizontal movement) relative to the second plate 220 (see, e.g., interlock mechanism 400 described in further detail below and illustrated in FIGS. 8A-8B and FIGS. 9A-9B).

As shown in FIG. 2C, in some embodiments, at least a portion of the upper end 212a of the front plate 210 may be offset a distance DI from the lower end 212b of the front plate 212b (i.e., the portion of the upper end 212a of the main body 212 extends on a first plane and the lower end 212b of the main body 212 extends on a second plane that is parallel, or otherwise offset from, to the first plane). In some embodiments, the portion of the upper end 212a may be offset from the lower end 212b a distance D1 of about 0.125 inches (⅛ inch). In some embodiments, the offset distance DI positions the main switch section 214 of the front plate 210 to avoid an obstruction that could prevent the front plate 210 from being positioned adjacent to the main switch 112 as the front plate 210 is moved (slid) relative to the panel assembly 102. For example, in some instances, the panel assembly 102 may comprise a protrusion or lip 104 where the main switch 112 passes through the cover 103 (see, e.g., FIG. 1). The offset in the main body 212 of the front plate 210 allows the front plate 210 to move (slide) over the lip 104 to engage with or disengage from the main switch 112 without being obstructed (i.e., the front plate 210 moves without contacting the lip 104).

As shown in FIG. 2B, the second (back) plate 220 of the interlock mechanism 200 has an elongate main body 222 having an upper end 222a and an opposing lower end 222b. In some embodiments, the upper end 222a of the main body 222 comprises a support section 224 extending generally perpendicular (transverse) to the main body 222. In some embodiments, the support section 224 is used to help position the back plate 220 on the electrical panel assembly 102 during installation of the interlock mechanism 200. In some embodiments, the upper end 222a of the back plate 220 further comprises a flanged edge 226 extending outwardly in an opposing direction from the support section 224.

As further shown in FIG. 2B, the main body 222 of the back plate 220 comprises one or more apertures 223. In some embodiments, the main body 222 of the back plate 220 comprises the same number of apertures 223 as slots 213 in the main body 212 of the front plate 210. For example, as shown in FIG. 2B, in some embodiments, the main body 222 of the back plate 220 may comprise three (3) apertures 223. In some embodiments, each aperture 223 is configured to receive a respective fastener 202, which allows the back plate 220 to be secured to the panel assembly 102. The apertures 223 are positioned in the main body 222 of the back plate 220 to align with a respective slot 213 of the front plate 210 such that the apertures 223 receive the same fastener 202 inserted through the slots 213 of the front plate 210 to movably secure the front plate 210 to the back plate 220 and the panel assembly 102.

In some embodiments, the back plate 220 is configured to support the front plate 210 on the panel assembly 102. In addition, in some embodiments, similar to the offset DI of the upper end 212a of the main body 212 of the front plate 210, the back plate 220 is configured to position the front plate 210 on the panel assembly 102 such that the front plate 210 can avoid obstructions on the panel assembly 102. For example, in some embodiments, the back plate 220 may position the front plate 210 an offset distance (e.g., a thickness of the back plate 220) such that the front plate 210 can move relative to the panel assembly 102 and avoid contacting a protrusion or lip 105 where the electrical circuits 114 (including the generator switch 122 and photovoltaic switch 132) pass through the cover 103 (see, e.g., FIG. 1). In addition, in some embodiments, securing the back plate 220 to the panel assembly 102 such that the back plate 220 resides between the panel assembly 102 and the front plate 210 allows the front plate 210 to move (slide) over the lip 105 to engage with or disengage from the generator switch 122 and/or photovoltaic switch 132 without being obstructed.

FIG. 3A and FIG. 3B illustrate exemplary use of the interlock mechanism 200 within the interlock assembly 100 according to embodiments of the present invention. FIG. 3A shows the interlock mechanism 200 positioned downwardly relative to the panel assembly 102 (as indicated by arrow F1). As shown in FIG. 3A, when the interlock mechanism 200 is in a “downward” position, the segment 214a of the main switch section 214 of the front plate 210 resides (is positioned) below the main switch 112 of the panel assembly 102 (i.e., the front plate 210 is “disengaged” from the main switch 112). At the same time, as shown in FIG. 3A, the segment 216a of the generator switch section 216 of the front plate 210 resides (is positioned) adjacent to the generator switch 122 (i.e., the front plate 210 is “engaged” with the generator switch 122) and the photovoltaic switch section 218 of the front plate 210 resides (is positioned) lower than the photovoltaic switch 132 (i.e., the front plate 210 is “disengaged” from the photovoltaic switch 132).

When the interlock mechanism 200 is positioned downwardly on the panel assembly 102 as shown in FIG. 3A, the main switch 112 of the panel assembly 102 is allowed to be moved into an “ON” position (as indicated by arrow A) and/or the photovoltaic switch 132 of the panel assembly 102 is allowed to be moved into an “ON” position (as indicated by arrow C), thereby establishing an electrical connection with the primary power source 110 and/or the photovoltaic system 130. It is noted that the main switch 112 and photovoltaic switch 132 are also able to be moved into an “OFF” position when the interlock mechanism 200 is in a downward position. At the same time, however, the generator switch 122 of the panel assembly 102 is locked in an “OFF” position (as indicated by arrow B) and thus, prevented from being moved into an “ON” position by the interlock mechanism 200 (i.e., the segment 216a of the generator switch section 216 of the front plate 210 prevents the generator switch 122 from being moved to the “ON” position), and thus, preventing an electrical connection being established with the generator system 120. Thus, the primary power source 110 is able to absorb any additional power that the photovoltaic system 130 may produce in excess of the load needed (e.g., by the house) without trying to “drive” the generator system 120 and potentially causing damage thereto.

FIG. 3B shows the interlock mechanism 200 positioned upwardly relative to the panel assembly 102 (as indicated by arrow F2). As shown in FIG. 3B, when the interlock mechanism 200 is in an “upward” position, the segment 214a of the main switch section 214 of the front plate 210 resides (is positioned) adjacent to the main switch 112 of the panel assembly 102 such that the main switch 112 is received within the recessed area 217 (i.e., the front plate 210 is “engaged” with the main switch 112). At the same time, as shown in FIG. 3B, the segment 216a of the generator switch section 216 of the front plate 210 resides above (is positioned away from) the generator switch 122 (i.e., the front plate 210 is “disengaged” from the generator switch 122) and the photovoltaic switch section 218 of the front plate 210 resides (is positioned) adjacent to the photovoltaic switch 132 (i.e., the front plate 210 is “engaged” with the photovoltaic switch 132).

When the interlock mechanism 200 is positioned upwardly on the panel assembly 102 as shown in FIG. 3B, the generator switch 122 of the panel assembly 102 is allowed to be moved into an “ON” position (as indicated by arrow B′), thereby establishing an electrical connection with the generator system 120. At the same time, however, the main switch 112 of the panel assembly 102 is locked in an “OFF” position (as indicated by arrow A′) and thus, prevented from being moved into an “ON” position by the interlock mechanism 200 (i.e., the segment 214a of the main switch section 214 of the front plate 210 (e.g., stop shoulder 215) prevents the main switch 112 from being moved to the “ON” position), thereby preventing an electrical connection from being established with the primary power source 110. In addition, the photovoltaic switch 132 of the panel assembly 102 is locked in an “OFF” positioned (as indicated by arrow C′) and thus, prevented from being moved into an “ON” position by the interlock mechanism 200 (i.e., the photovoltaic switch section 218 of the front plate 210 prevents the photovoltaic switch 132 from being moved into an “ON” position), thereby preventing an electrical connection from being established with the photovoltaic system 130. Thus, the primary power source 110 (i.e., main switch 112) and the photovoltaic system 130 (i.e., photovoltaic switch 132) are interlocked before the generator system 120 (i.e., generator switch 122) can be turned on.

As shown in FIG. 1, in some embodiments, the front plate 210 of the interlock mechanism 200 may comprise an indicator 207 configured to visibly indicate to a user the status of the interlock mechanism 200 (e.g., which switches or breakers 112, 122, 132 are operable or inoperable based on the position of the interlock mechanism 200). In some embodiments, the indicator 207 may be visible through an opening or transparent section in the door of the panel assembly 102, thereby allowing the position of the interlock mechanism 200 to be visible without opening the door.

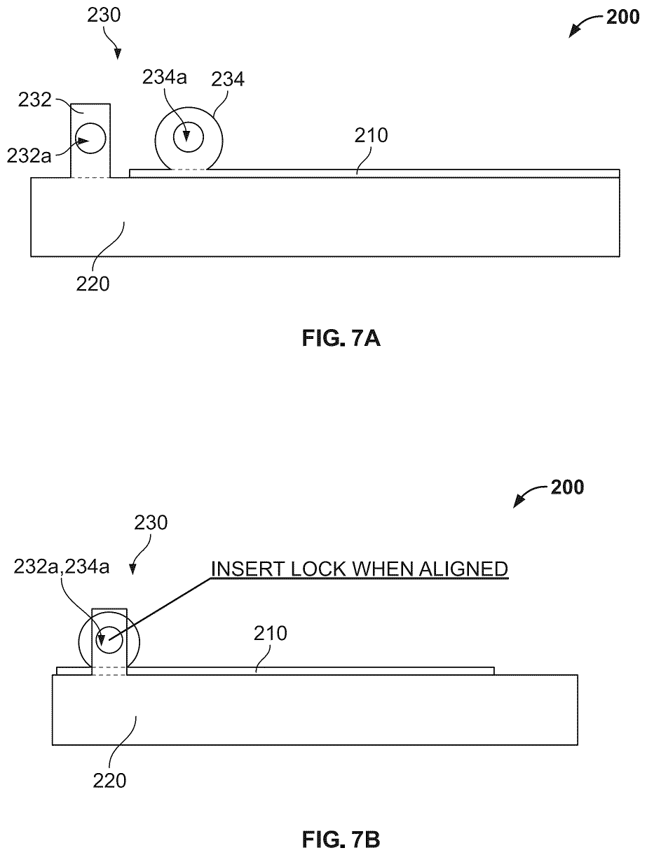

As further shown in FIG. 1, in some embodiments, the interlock mechanism 200 may further comprise one or more locking features 205. In some embodiments, the one or more locking features 205 may be configured to be received in a respective slot 213 of the front plate 210 to prevent movement of the front plate 210 relative to the back plate 220. Thus, the locking features 205 may be configured to secure the interlock mechanism 200, i.e., the front plate 210 in an upward or downward position relative to the back plate 220, thereby preventing unauthorized adjustment/movement of the interlock mechanism 200 (see also locking feature 230 shown in FIGS. 7A-7B and described in further detail below).

FIG. 4A illustrates an exemplary panel assembly 102 on which the interlock mechanism 200 of the present invention may be installed. As noted above, the panel assembly 102 may be of conventional construction (e.g., an electrical panel assembly), and may incorporate a standard, commercially available electrical load center. As described herein, the panel assembly 102 includes a panel cover 103 with a series of electrical circuits 114 extending through the cover 103. As shown in FIG. 4A, the electrical circuits 114 may be arranged in two columns 114-1, 114-2 within the panel assembly 102. As shown in FIG. 4B, to install the interlock mechanism 200 on the panel assembly 102, first, one or more holes 102a are formed (e.g., drilled) in a section of the cover 103 of the panel assembly 102 located between the two columns 114-1, 114-2 of electrical circuits 114. Each hole 102a is configured to receive a respective fastener 202 (FIG. 1) that secures the interlock mechanism 200 to the panel assembly 102. Next, the apertures 223 in the back plate 220 and the slots 213 in the front plate 210 are aligned with the holes 102a in the cover 103 of the panel assembly 102. Fasteners 202 are inserted through the aligned slots 213 and apertures 223 and into the holes 102a in the cover 103 of the panel assembly 102. The fasteners 202 are sufficiently tightened to secure the interlock mechanism 200 (i.e., the front plate 210 and back plate 220) to the panel assembly 102, but are loose enough to allow the front plate 210 to move (slide) relative to the back plate 220 (i.e., the fasteners 202 are capable to move up and down within the respective slots 213 of the front plate 210). Once the front plate 210 is moved into a desired position (e.g., downwardly or upwardly relative to the back plate 210 and panel assembly 102), the fasteners 202 may then be further tightened to secure the front plate 210 in the desired position.

FIGS. 5A-5E illustrate further exemplary usage of the interlock mechanism 200 within the interlock assembly 100 according to embodiments of the present invention. FIG. 5A illustrates an initial setup of the interlock assembly 100 after installation of the interlock mechanism 200 onto the panel assembly 102 with the main switch 112 moved in an “ON” position, thereby establishing an electrical connection with the primary or main (e.g., utility) power source 110. As shown in FIG. 5A, the front plate 210 of the interlock mechanism 200 is positioned downwardly relative to the panel assembly 102 (as indicated by arrow F1) (see also, e.g., FIG. 3A). In this position, the segment 214a of the main switch section 214 of the front plate 210 resides lower than (is positioned below) the main switch 112 of the panel assembly 102 (i.e., the front plate 210 is “disengaged” from the main switch 112), the segment 216a of the generator switch section 216 of the front plate 210 is positioned adjacent to the generator switch 122 (i.e., the front plate 210 is “engaged” with the generator switch 122), and the photovoltaic switch section 218 of the front plate 210 resides lower than (is positioned below) the photovoltaic switch 132 (i.e., the front plate 210 is “disengaged” from the photovoltaic switch 132).

As illustrated in FIG. 5B, while the interlock mechanism 200 remains in the initial setup position (i.e., the front plate 210 of the interlock mechanism 200 is positioned downwardly relative to the panel assembly 102), the main switch 112 may be moved to an “OFF” position (as indicated by arrow A′), thereby breaking (disconnecting) the electrical connection with the primary power source 110. As shown in FIG. 5B, the photovoltaic switch 132 is in the “ON” position (as indicated by arrow C) and the generator switch 122 remains in the “OFF” (as indicated by arrow B). The generator switch 122 is prevented from moving to an “ON” position by the interlock mechanism 200. The interlock mechanism 200 may remain secured in this position by further tightening of the fasteners 202.

As illustrated in FIG. 5C, while the front plate 210 of the interlock mechanism 200 remains positioned downwardly relative to the panel assembly 102, the photovoltaic switch 132 may be moved to an “OFF” position (as indicated by arrow C′). As shown in FIG. 5C, the generator switch 122 is still prevented from moving to an “ON” position by the interlock mechanism 200.

FIG. 5D illustrates the front plate 210 positioned upwardly relative to the back plate 220 (as indicated by arrow F2) such that the segment 214a of the main switch section 214 of the front plate 210 is positioned adjacent to the main switch 112 of the panel assembly 102 and the main switch 112 is received within the recessed area 217 (i.e., the front plate 210 is “engaged” with the main switch 112) (see also, e.g., FIG. 3B). At the same time, the segment 216a of the generator switch section 216 of the front plate 210 moves away from (positioned above) the generator switch 122 (i.e., the front plate 210 is “disengaged” with the generator switch 122 so that the generator switch 122 can be moved to an “ON” position) and the photovoltaic switch section 218 of the front plate 210 is positioned adjacent to the photovoltaic switch 132 (i.e., the front plate 210 is “engaged” from the photovoltaic switch 132 so that the photovoltaic switch 132 cannot be moved to an “ON” position). Thus, according to embodiments of the present invention, the interlock assembly 100 of the present invention is configured to prevent two power sources (e.g., main power source 110 and photovoltaic system 130) from being in the “ON” position, thereby meeting the requirements of Article 702 of the National Electric Code ANSI/NFPA 70.

As illustrated in FIG. 5E, while the front plate 210 of the interlock mechanism 200 is positioned upwardly relative to the panel assembly 102, the generator switch 122 (which is no longer engaged with the interlock mechanism 200) may be moved to an “ON” position (as indicated by arrow B′). At the same time, however, the main switch 112 of the panel assembly 102 is locked in an “OFF” position (as indicated by arrow A′) and thus, prevented from being moved into an “ON” position by the interlock mechanism 200 (i.e., the segment 214a of the main switch section 214 of the front plate 210 prevents the main switch 112 from being moved to the “ON” position). Similarly, the photovoltaic switch 132 of the panel assembly 102 is locked by the interlock mechanism 200 in an “OFF” position (as indicated by arrow C′) and thus, prevented from being moved into an “ON” position (i.e., the photovoltaic switch section 218 of the front plate 210 prevents the photovoltaic switch 132 from being moved into an “ON” position). The interlock mechanism 200 may be secured in this position by further tightening of the fasteners 202.

As described herein, methods of using an interlock mechanism 200 of the present invention to prevent a panel assembly 102 (e.g., an electrical panel assembly) from concurrently supplying power to a series of electrical circuits 114 from a primary power source 110 and at least two alternate power sources 120, 130 are provided. The method may include the steps of moving the front plate 210 of the interlock mechanism 200 downward relative to the back plate 220 of the interlock mechanism such that the upper end 212a of the front plate 210 engages with the first alternate power switch (e.g., generator switch 122) and disengages from the main switch 112 and the lower end 212b of the front plate 210 disengages from the second alternate power switch (e.g., photovoltaic switch 132) or alternatively, moving the front plate 210 upward relative to the back plate 220 such that the upper end 212a of the front plate 210 engages with the main switch 112 and disengages from the first alternate power switch (e.g., generator switch 122) and the lower end 212b of the front plate 210 engages with the second alternate power switch (e.g., photovoltaic switch 132); and tightening the fastener 202 to secure the front plate 210 from moving relative to the back plate 220.

Referring to FIGS. 7A and 7B, the interlock mechanism 200 of the present invention may comprise another type of locking feature 230 to secure the front plate 210 in an upward or downward position relative to the back plate, thereby preventing unauthorized adjustment/movement of the interlock mechanism 200. As shown in FIGS. 7A-7B, in some embodiments, the locking feature 230 of the interlock mechanism 200 is a hasp or similar locking mechanism. For example, as shown in FIG. 7A, the front plate 210 of the interlock mechanism 200 may comprises a staple 234 (or the like) and the back plate 220 of the interlock mechanism 220 may comprise a latch 232 (or the like). As shown in FIG. 7B, when an aperture 234a in the staple 234 is aligned with an aperture 232a in the latch 232, then a lock, e.g., a padlock (not shown), may be inserted through the aligned apertures 232a, 234a to secure the front plate 210 in the desired position relative to the back plate 220.

Referring now to FIGS. 8A-8B and FIGS. 9A-9B, an interlock assembly 300 utilizing an alternative interlock mechanism 400 according to embodiments of the present invention is illustrated. Properties and/or features of the interlock assembly 300 and interlock mechanism 400 may be as described above in reference to the interlock assembly 100 and interlock mechanism 200 described herein and duplicate discussion thereof may be omitted herein for the purposes of discussing FIGS. 8A-8B and FIGS. 9A-9B.

Similar to the interlock assembly 100 described herein, the interlock assembly 300 is configured to supply power to a series of electrical circuits 114 from one of at least three different power sources. Representatively, the interlock assembly 300 of the present invention controls the supply of power to the electrical circuits from a primary (main) power supply 110, such as utility power, and two or more alternate or secondary power sources which are adapted to supply power to the electrical circuits 114, for example, in the event power from the primary power supply 110 is unavailable. In some embodiments, the alternate or secondary power sources are a generator system 120 and a photovoltaic (solar) system 130 (see, e.g., FIG. 1), although it is understood that any other source of alternate or secondary power may be employed in the interlock assembly 100 of the present invention.

As shown in FIGS. 8A-8B, according to embodiments of the present invention, the interlock assembly 300 includes a panel assembly 102′ (e.g., an electrical panel assembly) and the alternative interlock mechanism 400. Apart from the interlock mechanism 400, the panel assembly 102′ is similar to the panel assembly 102 of interlock assembly 100 described herein. The panel assembly 102′ may be of conventional construction, and may incorporate a standard, commercially available electrical load center. In some embodiments, the panel assembly 102′ includes a panel cover 103′ having a door (not shown) pivotably connected thereto. Cover 103′ includes a series of knockouts 104′ constructed to be removed as electrical circuits 114′ (i.e., branch circuit or load breakers) are added to electrical panel assembly 102′. The electrical circuits 114′ are connected to an electrical panel busbar (not shown). In some embodiments, the electrical circuits 114′ include a main switch 112′ and at least two alternate switches 122′, 132′. It is noted that while the electrical panel busbar is not shown in the figures, one of ordinary skill in the art would understand that it would reside behind the cover 103′ of the panel assembly 102′. In some embodiments, the electrical circuits 114′ may be arranged within the panel assembly 102′ in two columns 114-1′, 114-2′.

The primary (main) source of electrical power 110, such as utility power, is supplied to the panel assembly 102′. The main switch (or breaker) 112′ passes through the cover 103′. In some embodiments, the main switch 112′ is constructed to be connected to the primary power source 110′. In some embodiments, a first alternate source of electrical power (e.g., from a generator system) may be supplied to the panel assembly 102′. A first switch (breaker) 122′ for the first alternate source of electrical power passes through one or more of the knockouts 104′ in the cover 103′ and is constructed to be connected to the first alternate source of electrical power (e.g., the generator system). As shown in FIGS. 8A-8B, in some embodiments, the switch 122′ for the first alternative source of power may reside proximate to the main switch 112′ along the electrical panel busbar (e.g., an upper segment of the busbar).

As further shown in FIGS. 8A-8B, in some embodiments, a second alternate source of electrical power (e.g., from a photovoltaic system) may also be supplied to the panel assembly 102′. A second switch (breaker) 132′ for the second alternative source of electrical power passes through one or more of the knockouts 104′ in the cover 103′ and is constructed to be connected to the second alternate source of electrical power (e.g., photovoltaic system). As shown in FIGS. 8A-8B, in some embodiments, the switch 132′ for the second alternative source of power may reside lower on the electrical panel busbar than the switch 122′ for the first alternative source of power. In some embodiments, the first or second alternate source of electrical power may be supplied from a battery system or EV application.

Similar to the interlock mechanism 200 described herein, according to some embodiments of the present invention, the interlock mechanism 400 is configured to prevent the connection (e.g., inadvertent) of the primary power source 110, the first alternative power source (e.g., generator system) and/or the second alternative power source (e.g., photovoltaic system) from being concurrently connected to the electrical circuits 114′ of the panel assembly 102′. In other words, in some embodiments, the interlock mechanism 400 is configured to prevent the main switch 112′ and at least two alternate switches 122′, 132′ from being concurrently connected to the series of electrical circuits 114′ of the panel assembly 102′. For example, in some embodiments, the interlock mechanism 400′ may be configured to interlock the main switch 112′ and the second switch 132′ before the first switch 122′ may be turned on, or interlock the first switch 122′ before the main switch 112′ and the second switch 132′ may be turned on. Also similar to the interlock mechanism 100 described herein, in some embodiments, the interlock mechanism 400 of the present invention may also be configured to interlock other or additional breakers or switches within the panel assembly 102′.

Components of the interlock mechanism 400 according to embodiments of the present invention are illustrated in greater in detail in FIGS. 9A-9B. As shown in FIG. 9A, the interlock mechanism 400 includes a first (or front) plate 410 (see also FIGS. 8A-8B). As shown in FIG. 9B, in some embodiments, the interlock mechanism 400 may further include a second (or back) plate 420 (see also FIGS. 8A-8B). The front plate 410 of the interlock mechanism 200 has a length L3 and a width W3. The interlock mechanism 400 (i.e., front and back plates 410, 420) may be formed from a variety of different materials, for example, steel, stainless steel, aluminum, aluminum alloys, ferrous and non-ferrous materials, plastics or polymers. In some embodiments, the front plate 410 has an overall length L3 in a range of between about 8 inches and about 10 inches and an overall width W1 in a range of between about 4 inches and about 6 inches. The back plate 420 of the interlock mechanism 400 also has a length L5 and a width W3. In some embodiments, the back plate 420 has an overall length L5 in a range of between about 4 inches and about 6 inches and an overall width W3 in a range of between about 4 inches and about 6inches. In some embodiments, the overall width W2 of the front plate 410 is equal to or substantially equal to the overall width W3 of the back plate 420.

As shown in FIG. 9A, the front plate 410 of the interlock mechanism 400 has a main body 412. In some embodiments, the main body 412 is generally C-shaped having an upper section 412a and an opposing lower section 412b that define a recessed section 417 residing therebetween. In some embodiments, a shoulder 415 extends into the recessed section 417. As discussed in further detail below, in some embodiments, when installed on the panel assembly 102′, the shoulder 415 may be configured to engage the main switch 112′. For example, in some embodiments, the recessed area 217 is configured to receive the main switch 112′ of the panel assembly 102′ (see, e.g., FIGS. 8A-8B), and the shoulder 415 is configured to engage with the main switch 112′ and prevent the main switch 112′ from connecting (e.g., inadvertently) to the primary power source 110′.

As further shown in FIG. 9A, in some embodiments, the front plate 410 includes an extension member 416 extending downwardly from the lower section 412b of the main body 412. The extension member 416 has a length L4. In some embodiments, the extension section 416 has a length L4 in a range of between about 3 inches and about 4 inches. In other embodiments, the extension section 416 may extend the length of the electrical busbar, thereby allowing engagement with a switch (e.g., a switch for an alternative power source) residing at the opposing end of the busbar from the main switch 112′ (for example, as noted above with respect to electrical codes in some jurisdictions).

In some embodiments, the extension member 416 comprises a first switch section 418 and a second switch section 419. In some embodiments, the first switch section 418 is configured to engage with the switch 122′ for the first alternative source of power and the second switch section 419 is configured to engage with the switch 132′ for the second alternative source of power or vice versa (see also FIGS. 8A-8B). In some embodiments, the first and second switch sections 418, 419 extend outwardly from the extension member 416 in opposing directions (i.e., extend transversely relative to the longitudinal axis of the extension member 416).

In some embodiments, similar to the front plate 210 of the interlock mechanism 200 described herein, the front plate 410 of the interlock mechanism 400 may comprise one or more additional electrical circuit sections (not shown) extending outwardly therefrom (i.e., extending outwardly transverse relative to the longitudinal axis of the extension member 416). The one or more additional electrical circuit sections may be configured to prevent a respective electrical circuit 114′ from establishing an electrical connection with an alternate circuit. The ability to add one or more electrical circuit sections on the front plate 410 allows the interlock mechanism 400 of the present invention to interlock (i.e., prevent movement) of various electrical circuits 114′ in diverse locations within the panel assembly 102′.

Still referring to FIG. 9A, the main body 412 of the front plate 410 (e.g., the upper and lower sections 412a, 412b) comprises one or more slots 413 aligned along a lateral axis of the upper and lower sections 412a, 412b of the front plate 210, respectively. For example, in some embodiments, the upper and lower sections 412a, 412b of the front plate 410 may each comprise two slots 413 (i.e., four total slots 413). In some embodiments, each slot 413 is configured to receive a respective fastener 402 (e.g., a screw and washer) which allows the interlock mechanism 400 to be movably secured to the panel assembly 102′. As discussed in further detail below, the fasteners 402 are also configured to traverse within the slots 413, thereby allowing the front plate 410 to move or slide relative to the panel assembly 102′ (and back plate 420) to engage or disengage the respective switches 112′, 122′, 132′, as desired (i.e., the slots 413 and fasteners 402 allow side-to-side movement (i.e., horizontal movement) of the front plate 410 relative to the second plate 420 and panel assembly 102′). In other embodiments, the front plate 410 may be configured to move up and down (i.e., vertical movement) relative to the second plate 420 (i.e., similar to the interlock mechanism 300 described herein).

Similar to the interlock mechanism 200 described herein, in some embodiments, at least a portion of the main body 412 of the front plate 410 may be offset a distance from the extension member 416 of the front plate 410 (i.e., the portion of the main body 412 extends on a first plane and the extension member 416 extends on a second plane that is parallel, or otherwise offset from, to the first plane) in order to avoid an obstruction that could prevent the front plate 410 from being positioned adjacent to the main switch 112′ as the front plate 410 is moved (slid) relative to the panel assembly 102′.

As shown in FIG. 8B, the second (back) plate 420 of the interlock mechanism 400 has a main body 422. The main body 422 is generally C-shaped having an upper section 422a and an opposing lower section 422b that define a recessed section 427 residing therebetween. In some embodiments, the upper end 222a of the main body 222 comprises a support section 224 extending generally perpendicular (transverse) to the main body 222. In some embodiments, the lower section 422b comprises an elongate opening 425 that may be used to help position the back plate 420 on the electrical panel assembly 102′ during installation of the interlock mechanism 400.

As further shown in FIG. 8B, the main body 422 of the back plate 420 (i.e., the upper and lower sections 422a, 422b) comprises one or more apertures 423. In some embodiments, the main body 422 of the back plate 420 comprises the same number of apertures 423 as slots 413 in the main body 412 of the front plate 410. For example, as shown in FIG. 8B, in some embodiments, the upper and lower sections 422a, 422b of the main body 422 of the back plate 420 may each comprise two apertures 423 (i.e., four total apertures 423). In some embodiments, each aperture 423 is configured to receive a respective fastener 402, which allows the back plate 420 to be secured to the panel assembly 102′. The apertures 423 are positioned in the main body 422 of the back plate 420 to align with a respective slot 413 of the front plate 410 such that the apertures 423 receive the same fastener 402 inserted through the slots 413 of the front plate 410 to movably secure the front plate 410 to the back plate 420 and the panel assembly 102′.

In some embodiments, the back plate 420 is configured to support the front plate 410 on the panel assembly 102′. In addition, in some embodiments, similar to the offset of the main body 412 of the front plate 410, the back plate 420 is configured to position the front plate 410 on the panel assembly 102′ such that the front plate 410 can avoid obstructions on the panel assembly 102′. For example, in some embodiments, the back plate 420 may position the front plate 410 an offset distance (e.g., a thickness of the back plate 420) such that the front plate 410 can move relative to the panel assembly 102′ and avoid contacting a protrusion or lip where the electrical circuits 114′ (including the switches 122′, 132′) pass through the cover 103′ (see, e.g., FIG. 1). In addition, in some embodiments, securing the back plate 420 to the panel assembly 102′ such that the back plate 420 resides between the panel assembly 102′ and the front plate 410 allows the front plate 410 to move (slide) over the lip to engage with or disengage from the switch 122′ and/or the switch 132′ without being obstructed.

Referring back to FIGS. 8A-8B, FIG. 8A shows the interlock mechanism 400 positioned in a first horizontal direction relative to the panel assembly 102′ (as indicated by arrow F3). As shown in FIG. 8A, when the interlock mechanism 400 is in the first horizontal position, the shoulder 415 of the main body 412 front plate 410 resides (is positioned) to the left of the main switch 112′ of the panel assembly 102′ (i.e., the front plate 410 is “disengaged” from the main switch 112′). At the same time, as shown in FIG. 8A, the first switch section 418 of the front plate 410 resides (is positioned) adjacent to the first switch 122′ (i.e., the front plate 410 is “engaged” with the switch 122′) and the second switch section 419 of the front plate 410 resides (is positioned) to the left of the second switch 132′ (i.e., the front plate 410 is “disengaged” from the switch 132′).

When the interlock mechanism 400 is positioned in the first horizontal position on the panel assembly 102′ as shown in FIG. 8A, the main switch 112′ of the panel assembly 102′ is allowed to be moved into an “ON” position (as indicated by arrow A) and/or the second switch 132′ of the panel assembly 102′ is allowed to be moved into an “ON” position (as indicated by arrow C). It is noted that the main switch 112′ and second switch 132′ are also able to be moved into an “OFF” position when the interlock mechanism 400 is in the first horizontal position. At the same time, however, the first switch 122′ of the panel assembly 102′ is locked in an “OFF” position (as indicated by arrow B) and thus, prevented from being moved into an “ON” position by the interlock mechanism 400 (i.e., the first switch section 418 of the front plate 410 prevents the first switch 122′ from being moved to the “ON” position), and thus, preventing an electrical connection being established.

FIG. 8B shows the interlock mechanism 400 positioned in a second opposing horizontal position relative to the panel assembly 102′ (as indicated by arrow F4). As shown in FIG. 8B, when the interlock mechanism 400 is in the second opposing horizontal position, the main body 412 of the front plate 410 resides (is positioned) adjacent to the main switch 112′ of the panel assembly 102′ (i.e., the shoulder 415 of the main body 412 of the front plate 210 is “engaged” with the main switch 112′). At the same time, as shown in FIG. 8B, the first switch section 418 of the front plate 410 is positioned away from the first switch 122′ (i.e., the front plate 410 is “disengaged” from the first switch 122′) and the second switch section 419 of the front plate 410 resides (is positioned) adjacent to the second switch 132′ (i.e., the front plate 410 is “engaged” with the second switch 132′).

When the interlock mechanism 400 is positioned in the second opposing horizontal position on the panel assembly 102′ as shown in FIG. 8B, the first switch 122′ of the panel assembly 102′ is allowed to be moved into an “ON” position (as indicated by arrow B′), thereby establishing an electrical connection. At the same time, however, the main switch 112′ of the panel assembly 102′ is locked in an “OFF” position (as indicated by arrow A′) and thus, prevented from being moved into an “ON” position by the interlock mechanism 400 (i.e., the shoulder 415 of the front plate 410 prevents the main switch 112′ from being moved to the “ON” position), thereby preventing an electrical connection from being established with the primary power source 110′. In addition, the second switch 132′ of the panel assembly 102′ is locked in an “OFF” positioned (as indicated by arrow C′) and thus, prevented from being moved into an “ON” position by the interlock mechanism 400 (i.e., the second switch section 419 of the front plate 410 prevents the second switch 132′ from being moved into an “ON” position), thereby preventing an electrical connection from being established. Thus, the main switch 112′ and the second switch 132′ are interlocked before the first switch 122′ can be turned on.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. An interlock assembly adapted to interact with a plurality of circuits, switches and/or toggles to direct a desired flow of energy, the interlock assembly comprising:
an electrical panel assembly comprising a cover and a series of electrical circuits including a main switch and at least two alternate switches; and
an interlock mechanism movably connected to the electrical panel assembly, the interlock mechanism configured to prevent the main switch and the at least two alternate switches from being concurrently engaged based on the desired flow of energy.

2. The interlock assembly according to claim 1, wherein the main switch is connected to a primary power source and the at least two alternate switches are each connected to a respective one of at least two alternate power sources.

3. The interlock assembly according to claim 2, wherein the at least two alternate power sources comprise a generator system and a photovoltaic system, and wherein the at least two alternate switches comprise a generator switch connected to the generator system and a photovoltaic switch connected to the photovoltaic system.

4. The interlock assembly according to claim 2, wherein one of the at least two alternate power sources comprise a battery system.

5. The interlock assembly according to claim 1, wherein the main switch is connected to a primary power source and one of the at least two alternate switches is connected to an air conditioning system or a refrigerator unit.

6. The interlock assembly according to claim 3, wherein the photovoltaic switch resides at an opposing end of the electrical panel assembly in relation to the main switch.

7. The interlock assembly according to claim 1, wherein the interlock assembly comprises an elongate first plate and an elongate second plate, wherein the second plate is affixed to the cover of the electrical panel assembly and the first plate is movably secured to the second plate.

8. The interlock assembly according to claim 7, wherein an upper end of the first plate is configured to engage with the main switch and/or a generator switch and a lower end of the first plate is configured to engage with a photovoltaic switch.

9. The interlock assembly according to claim 8, wherein the upper end of the first plate comprises a main switch section configured to engage the main switch and a generator switch section configured to engage the generator switch.

10. The interlock assembly according to claim 8, wherein the lower end of the first plate comprises a photovoltaic switch section configured to engage a photovoltaic switch.

11. The interlock assembly according to claim 7, wherein the first plate comprises one or more slots configured along a longitudinal axis of the first plate and the second plate comprises one or more apertures configured to align with the one or more slots in the first plate, wherein a fastener is received through each aligned slot and aperture to secure the first and second plates to the electrical panel assembly, and wherein the slots and fasteners allow up and down movement of the first plate relative to the second plate.

12. The interlock assembly according to claim 8, wherein a portion of the upper end of the first plate is offset relative to the lower end of the first plate.

13. The interlock assembly according to claim 8, wherein the upper end of the second plate comprises a support section extending generally transverse to a longitudinal axis of the second plate.

14. The interlock assembly according to claim 13, wherein the upper end of the second plate further comprises a flanged edge extending outwardly in an opposing direction from the support section.

15. The interlock assembly according to claim 7, wherein the first plate of the interlock assembly longitudinally extends between the main switch and a photovoltaic switch.

16. The interlock assembly according to claim 7, wherein the first plate comprises one or more additional electrical circuit sections extending outwardly therefrom relative to the longitudinal axis of the first plate, wherein the one or more additional electrical circuit sections configured to lock a respective one of the series of electrical circuits from an electrical connection.

17. The interlock assembly according to claim 7, wherein the interlock mechanism further comprises one or more locking features configured to secure the front plate in an upward or a downward position relative to the back plate and prevent unauthorized adjustment of the interlock mechanism.

18. The interlock assembly according to claim 7, wherein the front plate of the interlock mechanism comprises an indicator configured to visibly indicate to a user which switches are engaged by the interlock mechanism.

19. The interlock assembly according to claim 1, wherein the interlock mechanism is configured to interact with at least three circuits, switches and/or toggles of the electrical panel assembly.

1. interlock assembly according to claim 1, wherein the interlock mechanism is configured to be modified to accommodate National Electric Code requirements.

21. An interlock assembly adapted to interact with a plurality of circuits, switches and/or toggles to direct a desired flow of energy from a primary power source and at least two alternate power sources, wherein the at least two alternate power sources comprise a generator system and a photovoltaic system, the electrical interlock assembly comprising:
an electrical panel assembly comprising a cover, a series of electrical circuits, a main power switch connected to the primary power source, and at least two alternate power switches, the at least two alternate power switches comprise a generator switch connected to the generator system and a photovoltaic switch connected to the photovoltaic system; and
an interlock mechanism movably connected to the electrical panel assembly, the interlock mechanism configured to prevent the primary power source and the photovoltaic system from being concurrently connected to the series of electrical circuits of the electrical panel assembly at the same time as the generator system, or prevent the generator system from being concurrently connected to the series of electrical circuits of the electrical panel assembly at the same time as the primary power source and the photovoltaic system.

22. The interlock assembly according to claim 21, wherein the photovoltaic switch resides at an opposing end of the electrical panel assembly in relation to the main power switch.

23. The interlock assembly according to claim 21, wherein the interlock assembly comprises an elongate first plate and an elongate second plate, wherein the second plate is affixed to the cover of the electrical panel assembly and the first plate is movably secured to the second plate.

24. The interlock assembly according to claim 23, wherein an upper end of the first plate is configured to engage with the main power switch and/or the generator switch and a lower end of the first plate is configured to engage with the photovoltaic switch.

25. The interlock assembly according to claim 24, wherein the upper end of the first plate comprises a main switch section configured to engage the main power switch and a generator switch section configured to engage the generator switch.

26. The interlock assembly according to claim 24, wherein the lower end of the first plate comprises a photovoltaic switch section configured to engage the photovoltaic switch.

27. The interlock assembly according to claim 23, wherein the first plate comprises one or more slots configured along a longitudinal axis of the first plate and the second plate comprises one or more apertures configured to align with the one or more slots in the first plate, wherein a fastener is received through each aligned slot and aperture to secure the first and second plates to the electrical panel assembly, and wherein the slots and fasteners allow up and down movement of the first plate relative to the second plate.

28. The interlock assembly according to claim 23, wherein a portion of the upper end of the first plate is offset relative to the lower end of the first plate.

29. The interlock assembly according to claim 23, wherein the upper end of the second plate comprises a support section extending generally transverse to a longitudinal axis of the second plate.

30. The interlock assembly according to claim 27, wherein the upper end of the second plate further comprises a flanged edge extending outwardly in an opposing direction from the support section.

31. The interlock assembly according to claim 22, wherein the first plate of the interlock assembly longitudinally extends between the main switch and the photovoltaic switch.

32. The interlock assembly according to claim 22, wherein the first plate comprises one or more additional electrical circuit sections extending outwardly therefrom relative to the longitudinal axis of the first plate, wherein the one or more additional electrical circuit sections configured to lock a respective one of the series of electrical circuits from an electrical connection.

33. An interlock mechanism for an electrical panel assembly, the interlock mechanism comprising:
a back plate comprising a first end, an opposing second end, and an aperture on the opposing first and second ends configured to receive a fastener to affix the back plate to the electrical panel assembly; and
a front plate comprising a first end, an opposing second end, and a slot aligned along a longitudinal or latitudinal axis of the front plate between the first and second opposing ends, wherein the slot is configured to align with the aperture in the back plate such that, when the fastener is received through the aligned aperture and slot, the front plate can move relative to the back plate, wherein movement of the front plate relative to the back plate allows the first end of the front plate to engage with a main power circuit, switch or breaker and a first alternate power circuit, switch, or breaker of the electrical panel assembly and allows the opposing second end of the front plate to engage with a second alternate power circuit, switch, or breaker of the electrical panel assembly, thereby preventing the main power circuit, switch, or breaker and the first and/or second alternate power circuit, switch, or breaker from being improperly engaged based on a desired flow of energy.

34. The interlock mechanism according to claim 33, wherein the first alternate power circuit, switch, or breaker is connected to a generator system and the second alternate power circuit, switch, or breaker is connected to a photovoltaic system.

35. The interlock mechanism according to claim 33, wherein the first end of the front plate comprises a main switch section configured to engage the main power circuit, switch, or breaker and a generator switch section configured to engage the first alternate power circuit, switch, or breaker.

36. The interlock mechanism according to claim 33, wherein the second opposing end of the front plate comprises a photovoltaic switch section configured to engage the second alternate power circuit, switch, or breaker.

37. The interlock mechanism according to claim 33, wherein a portion of the first end of the front plate is offset relative to the second opposing end of the front plate such that the portion of the first end of the front plate extends along a first plane and the second opposing end of the first plate extends along a second plane that is parallel to the first plane.

38. The interlock mechanism according to claim 33, wherein the first end of the back plate comprises a support section extending generally perpendicular to a longitudinal axis of the back plate.

39. The interlock mechanism according to claim 38, wherein the first end of the back plate further comprises a flanged edge extending outwardly in an opposing direction from the support section.

40. The interlock mechanism according to claim 33, wherein the front plate longitudinally extends between the main power circuit, switch, or breaker and the second alternate power circuit, switch, or breaker when the second alternate power circuit, switch, or breaker resides at an opposing end of the electrical panel assembly from the main power circuit, switch, or breaker.

41. The interlock mechanism according to claim 33, wherein the electrical assembly comprises one or more additional electrical circuit sections extending outwardly therefrom relative to the longitudinal axis of the front plate, wherein the one or more additional electrical circuit sections configured to lock a respective one of a series of electrical circuits of the electrical panel assembly from an electrical connection.

42. The interlock mechanism according to claim 33, wherein the fastener allows the front plate to be adjustably fixed in a desired position relative to the back plate.

43. A method of installing an interlock mechanism to an electrical panel assembly for the purpose of creating a capacity threshold in the electrical panel assembly to protect integrated power sources from overloading caused by high amperage appliances, the electrical panel assembly including at least three breakers that need to be controlled when a power source is supplying power within the electrical panel assembly, and the interlock mechanism including a back plate having a first end, an opposing second end, and an aperture between the opposing ends and a front plate having a first end, an opposing second end, and a slot aligned along a longitudinal or latitudinal axis of the front plate between the front plate first end and the front plate opposing second end, wherein a fastener is received through the aperture and the slot to movably secure the interlock assembly to the electrical panel assembly, the method comprising:
moving the front plate of the interlock mechanism in a first direction relative to the back plate of the interlock mechanism such that the first end of the front plate engages with a first breaker and disengages from a second breaker and the opposing second end of the front plate disengages from a third breaker or alternatively, moving the front plate in a second opposing direction relative to the back plate such that the first end of the front plate engages with the first breaker and disengages from the second breaker and the opposing second end of the front plate engages with the third breaker; and
tightening the fastener to secure the front plate from moving relative to the back plate.

44. The method according to claim 43, wherein the second breaker is connected to a generator system and the third breaker is connected to a photovoltaic system.

45. The method according to claim 43, wherein the first breaker is connected to a primary power source and the second and third breakers are each connected to a respective one of at least two alternate power sources.

46. The method according to claim 45, wherein the at least two alternate power sources comprise a generator system and a photovoltaic system, and wherein the at least two alternate switches comprise a generator switch connected to the generator system and a photovoltaic switch connected to the photovoltaic system.

45. The method according to claim 45, wherein one of the at least two alternate power sources comprise a battery system.

48. The method according to claim 43, wherein the first breaker is connected to a primary power source and one of the second or third breakers is connected to an air conditioning system or a refrigerator unit.

49. An interlock assembly adapted to interact with a plurality of circuits, switches, and/or toggles to direct a desired flow of energy from a primary power source and at least two alternative power sources, wherein the at least two alternative power sources require a transfer switch configured to prevent a potential catastrophic or fatal flow of energy, the interlock assembly comprising:
an electrical panel assembly comprising a cover, a series of electrical circuits, a main power switch connected to the primary power source, and the two alternate power sources, wherein one of the alternative power sources is a grid-tied power system configured to feed surplus power back to a utility and the other alternative power source is an independent power system from the grid-tied power system operating as standby emergency power; and an interlock mechanism movably connected to the electrical panel assembly, the interlock mechanism configured to prevent the primary power source and the grid-tied power system from being concurrently connected to the series of electrical circuits of the electrical panel assembly at the same time as the independent power system, or prevent the independent power system from being concurrently connected to the series of electrical circuits of the electrical panel assembly at the same time as the primary source and the grid-tied power system.
